(19) United States
(12) Patent Application Publication
(10) Pub. No.: US 2008/0104206 A1
(43) Pub. Date: May 1, 2008

(54) EFFICIENT KNOWLEDGE REPRESENTATION IN DATA SYNCHRONIZATION SYSTEMS

(75) Inventors: Lev Novik, Bellevue, WA (US); Moe Khosravy, Kirkland, WA (US); Michael Ray Clark, Redmond, WA (US); Philip Austin Vaughn, Kirkland, WA (US); Oliver C. Lee, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/673,129

(22) Filed: Feb. 9, 2007

Related U.S. Application Data
(60) Provisional application No. 60/863,578, filed on Oct. 31, 2006.

(51) Int. Cl. G06F 15/177; G06F 15/16

(52) U.S. Cl. 709/220; 709/227

(57) ABSTRACT

An efficient way is provided to represent and exchange knowledge across nodes when synchronizing between any two nodes. A first node sends a second node its knowledge, including objects and versions of those objects. The second node compares its knowledge with the knowledge of the first node, and then sends the first node any latest versions of objects of which the first node is unaware. In addition, the second node sends its knowledge to the first node. The first node then performs a similar object-by-object version comparison to determine any conflicts due to independent evolution of objects and any changes that should be sent to the second node in order to bring the objects of the second node up to date with the knowledge of the first node.

### CROSS-REFERENCE TO RELATED APPLICATIONS

This application claims priority to U.S. Provisional Patent Application Ser. No. 60/863,578 filed Oct. 31, 2006, entitled “EFFICIENT KNOWLEDGE REPRESENTATION IN DATA SYNCHRONIZATION SYSTEMS”. The entirety of this application is incorporated herein by reference.

### TECHNICAL FIELD

The subject disclosure relates an efficient way to represent synchronization knowledge across distributed devices so that the devices can understand changes to send to each other in order to synchronize.

### BACKGROUND

There are a variety of distributed data systems that have devices and objects that share data with one another. For instance, music sharing systems may synchronize music between a PC, a Cell phone, a gaming console and an MP3 player. Email data may be synchronized among a work server, a client PC, and a portable email device. Today, to the extent such devices synchronize according to common information, the synchronization takes place according to a static setup among the devices. However, when these devices are loosely coupled such that they may become disconnected from communications with each other, e.g., when a Cell phone is in a tunnel, or when the number of devices to be synchronized is dynamic, it is desirable to have a way for the devices to determine what changes each other device needs when they re-connect to one another, or as they join the network.

Today, as shown in FIG. 1, there are various examples where a master node 100 synchronizes in a dedicated manner with a client node 110, such as when an email server synchronizes with an email client. Due to the dedicated synchronization between the two devices, the state of the necessary knowledge 102 to synchronize between the two devices can be tracked by the master node 100. Such knowledge 102 can also optionally be tracked by client node 100 as well, however, when the connection between master node 100 and client node 110 becomes disconnected at times, and when the number of synchronizing devices increases, tracking the necessary knowledge across all of those devices becomes a difficult problem.

The problem with current solutions is that they often base their synchronization semantics solely on clocks or logical watermarks for a specific node (e.g., the email server), as opposed to any node. These systems can work well in cases of a single connecting node or master. However, they run into problems when the topology or pattern in which the nodes connect changes unpredictably.

Thus, a need for node-independent synchronization knowledge arises when computers in a topology change the way they connect to each other or as the number of computers grows. For instance, with a media player, it might be desirable to synchronize among multiple computers and multiple websites. In most instances, most applications can only synchronize data between a few well-known endpoints (home pc and media player). As the device community evolves over time for a user of the media player application, however, the need for data synchronization flexibility for the music library utilized by the devices increases, thereby creating the need for a more robust system.

Thus, any distributed data system that wishes to share common information across multiple loosely coupled devices needs an efficient way to represent what changes to the common information of which they are aware and what changes of which they are unaware. For a conceptual illustration of the problem, imagine four friends who each go see a sneak preview of an upcoming movie. Unfortunately, the movie studio has decided to limit distribution of the movie and each friend is limited to seeing only a thirty-minute segment of the movie. When the friends get back together, they have a meeting where each describes the beginning through the end of the segment they watched to attempt to collectively piece together as much of the movie as possible.

If, by chance however, the fourth friend cannot attend the meeting, then the one of the first three friends, e.g., the second friend, who talks to the fourth friend next will attempt to add the collective knowledge of the movie by the first three friends to the knowledge of the movie by the fourth friend. At that time, however, the complete set of knowledge of the movie as between the four friends is understood only by the second and fourth friends. Then, when either of the first friend or third friend encounters either of the second or fourth friend, the first or the third friend will gain the collective knowledge of the movie as well. Synchronization is finally complete when each of the four friends understands the collective knowledge of the movie by the four friends.

In the above example, the movie is analogous to common information to be shared across devices and the friends are analogous to the loosely coupled devices. In this regard, when the friends/devices come back together, what is needed is a mechanism for representing what each of the connected individuals/devices know and do not know, so that the common information can be pieced together to the maximum extent permitted by the collective knowledge of the individuals/devices. Loosely connected systems of device nodes thus need an efficient way to describe the data they have, where they received and what data they need from another node involved in the conversation.

In this regard, complications arise when attempting to synchronize among loosely coupled devices when there is no mechanism for understanding the collective knowledge of the set of devices that are connected. Additional detail about these and other deficiencies in the current state of synchronization among loosely coupled devices may become apparent from the description of the various embodiments of the invention that follows.

### SUMMARY

In consideration of the need for knowledge exchange among multiple nodes of a synchronization network, which may independently evolve common information to be synchronized across the nodes, the invention provides an efficient way to represent and exchange knowledge across nodes when synchronizing between any two nodes. In various non-limiting embodiments, a first node sends a second node its knowledge, including objects and versions of those objects. The second node compares its knowledge with the knowledge of the first node, and then sends the first node any latest versions of objects of which the first node is unaware. In addition, the second node sends its knowledge to the first node. The first node then performs a similar object-by-object version comparison to determine any conflicts due to independent evolution of objects and any changes that should be sent to the second node in order to bring the objects of the second node up to date with the knowledge of the first node.

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments of the invention in a simplified form as a prelude to the more detailed description of the various embodiments of the invention that follows.

### BRIEF DESCRIPTION OF THE DRAWINGS

The system and methods for representing synchronization knowledge for multiple nodes sharing common information are further described with reference to the accompanying drawings in which:

FIG. 1 illustrates a dedicated synchronization system that provides synchronization between two well defined endpoints of the system;

FIG. 2A illustrates exemplary non-limiting knowledge exchange between two nodes of a loosely connected network of nodes in accordance with the invention;

FIG. 2B is a block diagram of an exemplary non-limiting implementation of a device for performing a knowledge exchange in accordance with the invention;

FIG. 3 illustrates exemplary non-limiting knowledge exchange between four nodes of a loosely connected network of nodes in accordance with the invention;

FIG. 4 illustrates exemplary non-limiting knowledge exchange between four nodes of a loosely connected network of nodes in accordance with the invention when some of the devices become disconnected from one another;

FIGS. 5A, 5B and 5C illustrate exemplary knowledge exchange in the context of multiple objects shared among nodes of a network in accordance with the invention;

FIG. 6 is an exemplary non-limiting flow diagram illustrating the process for knowledge exchange in the context of multiple objects shared among nodes of a network in accordance with the invention;

FIG. 7 is a block diagram representing an exemplary non-limiting networked environment in which the present invention may be implemented; and

FIG. 8 is a block diagram representing an exemplary non-limiting computing system or operating environment in which the present invention may be implemented.

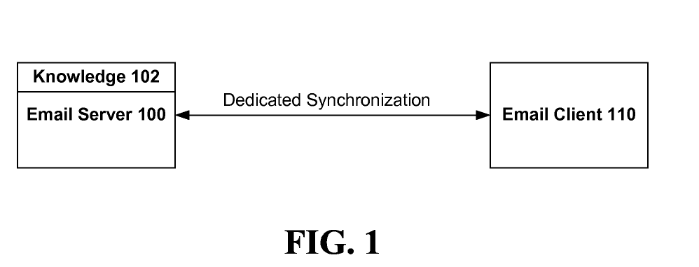

### DETAILED DESCRIPTION

### Overview

As discussed in the background, there is no way to efficiently represent synchronization knowledge for a set of loosely coupled devices that do not remain in dedicated contact with one another. Where dedicated contact can be presumed, any changes can immediately or periodically be pushed out to the devices that should receive them. Where dedicated contact cannot be presumed, however, with devices appearing and disappearing, efficiently representing what those devices know and do not know from a synchronization standpoint is desirable.

Accordingly, the invention enables efficient knowledge representation for distributed devices in data synchronization systems. An efficient mechanism is provided to ensure whenever a device has access to other device(s) in a loosely coupled network, the device will exchange knowledge with the other device(s) in order to determine which changes should be retrieved by the device and conveyed to the other device(s).

In this fashion, while a first device and a third device may never communicate directly, if each is able to connect to a second device, a collective share of knowledge can be achieved across all three devices, determining what changes each of the devices should receive from each of the other devices. Considering the proliferation of devices that share data, such as music, email, pictures, videos, advantageously, the knowledge exchange techniques of the invention are scalable to any number of devices, and any number of independent knowledge bases (i.e., different sets of common information) simultaneously, i.e., anywhere any evolving set of devices wish to share data. Various embodiments of representing such knowledge in a distributed system are described in more detail below.

### Efficient Knowledge Representation and Exchange

In various exemplary, non-limiting embodiments described below, knowledge is efficiently represented in data synchronization systems. Non-limiting benefits that can be achieved with the invention include an efficient exchange of knowledge between connected devices that can send only the minimum data needed by a first node from a second node, the ability to efficiently and correctly recognize disagreements over the state of data, i.e., conflicts, between a first node and a second node, the ability to synchronize an arbitrary number of nodes and the ability to synchronize any node via any other node, i.e., the ability to work in a peer to peer, multi-master synchronization environment.

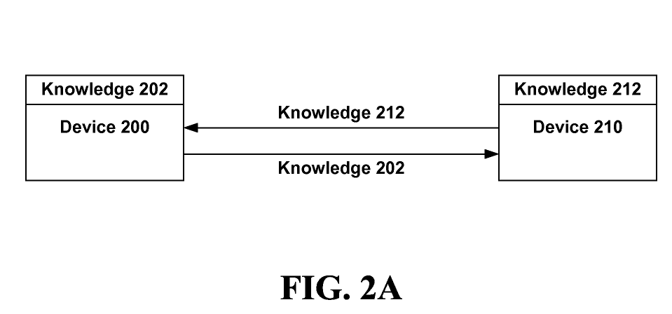

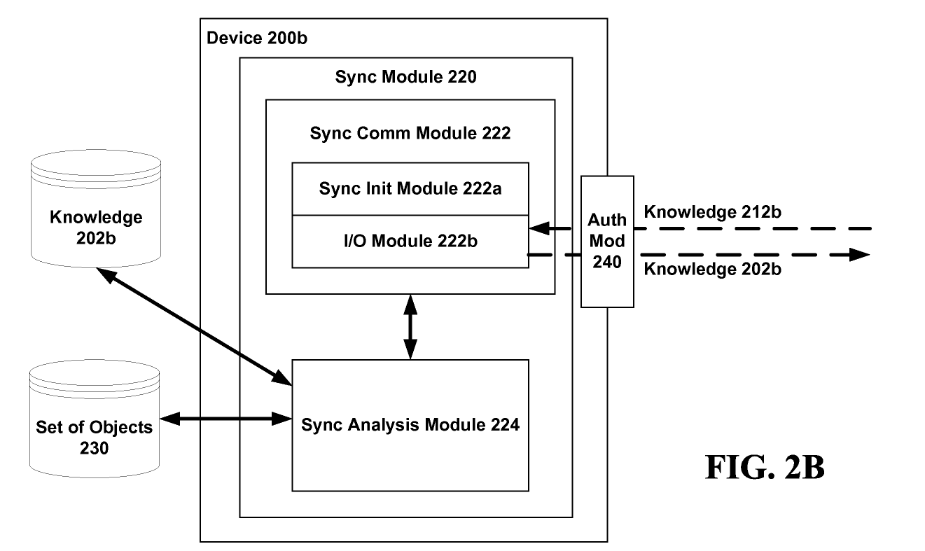

FIG. 2A illustrates, at a high level, the knowledge exchange of the invention between two devices 200 and 210. In accordance with the invention, any number of changes might be made to some information that is to be shared between the two devices 200 and 210. At any time they become connected, however, by exchanging their knowledge 202 and 212, they become aware of at least the minimum amount of information needed to reconstruct what each other knows and doesn't know to facilitate of changes between the devices. It is noted that where more than two devices are involved, knowledge 202 and 212 may be incomplete knowledge of a greater base of information to be shared, but as more knowledge is shared around the multiple devices, collective knowledge continues to be accrued by the devices as they connect to the other devices over time.

FIG. 2B is a block diagram of an exemplary non-limiting implementation of a device 200b for performing a knowledge exchange in accordance with the invention. As shown, device 200b includes a sync module 220 that performs the knowledge exchange techniques for synchronizing a set of objects 230 with another device in accordance with the invention. Sync module 220 may include a sync communications module for generally transmitting and receiving data in accordance with the knowledge exchange techniques of the invention.

Sync module 220 may include a sync initiation module 222a which may initiate synchronization with a second device if authorized, e.g., via authorization module 240, and connected to the second device. Sync module may also include an I/O module responsive to the initiation of synchronization by sending knowledge 202b about the set of objects 230 to the second device (not shown) and for receiving back knowledge 212b of the second device and changes to be made to the set of objects 230 originating from the second device. In turn, a sync analysis module 224 operates to apply the changes to be made to the set of objects 230 and to compare knowledge 212b from the second device with the knowledge 202b of the first device in order to determine changes to send to the second device to complete synchronization between the devices.

Advantageously, the invention operates to perform synchronization for a set of devices all interested in maintaining the latest versions of a set of objects, but also allows such devices to come into connection and out of connection with the other objects of the set. Whenever a device comes back into connection with other device(s) of the set of devices via one or more networks, the device regains collective knowledge that is as up to date as the other device(s) represent with their collective knowledge. In this fashion, even loosely connected devices may come into and out of contact with a set of devices, and then relearn all the knowledge it has missed by coming into contact with any set of devices that possesses the latest set of collective knowledge.

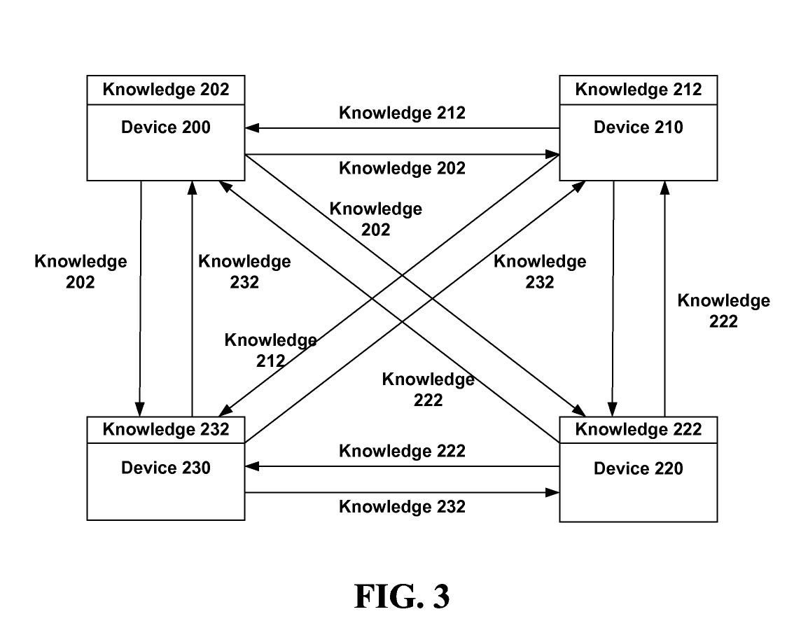

FIG. 3 illustrates that the knowledge exchange of the invention is generalizable, or scalable, to any number of devices. As shown, four devices 200, 210, 220 and 230 are shown with knowledge representations 202, 212, 222 and 232 that respectively indicate what each device knows and doesn't know about a set of common information to be shared across the devices.

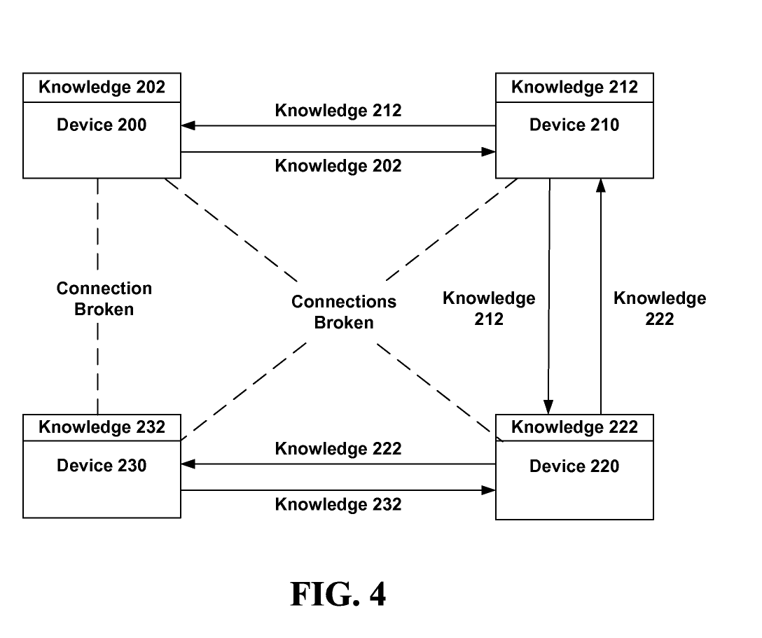

Advantageously, as shown by FIG. 4, even where connections in the network become disconnected, a complete set of knowledge can nonetheless be gained by all of the devices 200, 210, 220, and 230, as long as at least one connection directly or indirectly exists to the other devices. For instance, as shown, knowledge 232 of device 230 still reaches device 200 via the knowledge exchange with device 220, then via the knowledge exchange between device 220 and 210, and finally via the knowledge exchange between device 210 and 200.

With more devices sharing knowledge about common information to be shared, all of the devices benefit because the knowledge exchange of the invention is agnostic about from which device collective knowledge comes. Much like the scenario described in the background of the invention where three friends exchange movie knowledge and then any one of the three meet with a fourth friend to put the whole picture together, the devices of the invention each independently operates to try to gain as much knowledge about information to be shared among the devices from any of the other devices to which it is connected.

In turn, much like the scenario described in the background where the second friend meets the fourth friend first, and where only the second and fourth friend share the collective knowledge of all four as a result, the first and third friend nonetheless benefit because it is unknown whether the first friend will see the second friend next or the fourth friend next, but the first friend will learn the collective knowledge from either. The same applies to the third friend. Similarly, connected devices of the invention exchanging common information benefit from any other knowledge accrued by any other connected devices because knowledge is collective per all of the other devices with which each of the exchanging devices has had prior contact.

In exemplary non-limiting detail, a method is described in further detail for two nodes to engage in a conversation and at the end of the conversation to have equivalent knowledge for the concerned data set. As illustrated above in connection with FIGS. 2 through 4, the invention is scalable beyond two nodes by creating a knowledge exchange capability for each new device entering the peer-to-peer network.

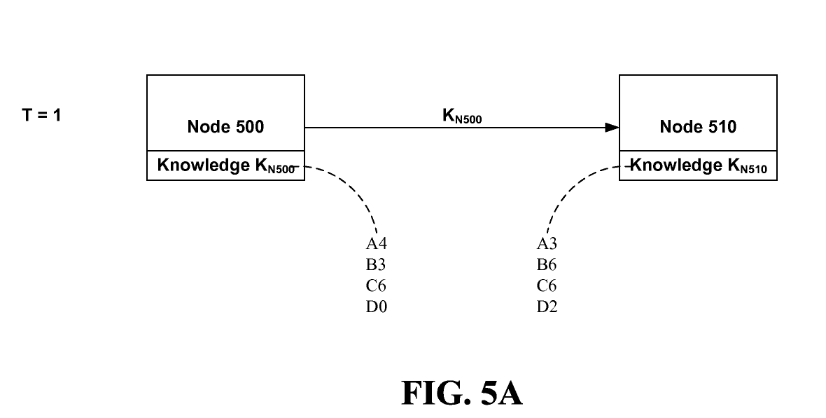

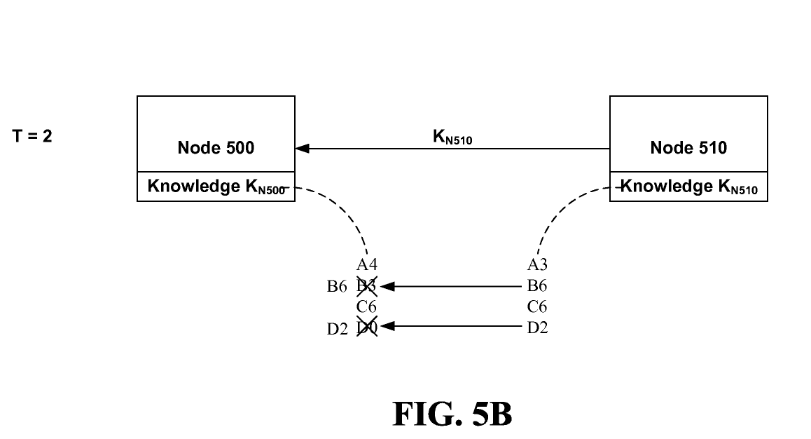

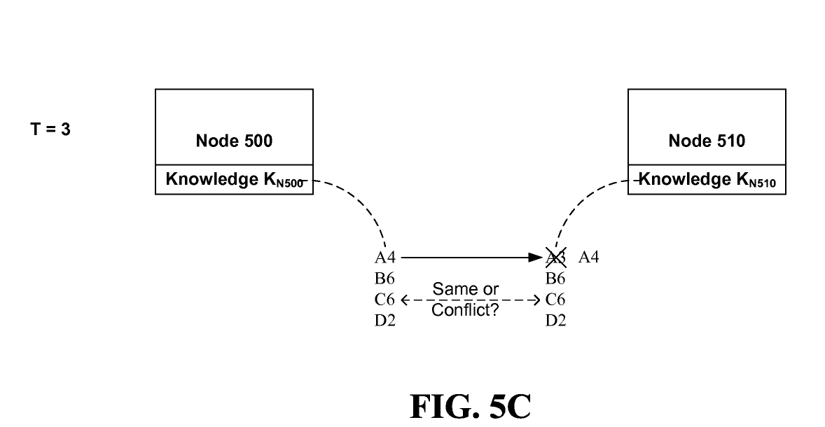

Thus, as shown in FIG. 5, node 500 of a peer-to-peer network having any number of nodes wants to exchange data with Node 5 10. Node A begins by requesting changes from Node 510 and in order to do so Node 500 sends its knowledge (represented as K_{N500}) to Node 510 as shown.

In the example shown, exemplary knowledge of a device or node is represented by labeling each object to be shared among devices with a letter identifier, and then the trailing number represents the latest version for this object. For instance, K_{N500} as shown in FIG. 5A includes objects A, B, C and D each to be synchronized between nodes 500 and 510, and the number following each of the objects represents the latest version of the object known on the device. For instance, knowledge K_{N500} at a time t=1 includes the 5^{th} version of A, the 4^{th} version of B, the 7^{th} version of C, and the 1^{st} version of D, notated as A4, B3, C6, D0 in FIG. 5. In contrast, knowledge K_{N510} of node 510 at a time t=1 may include the 4^{th} version of A, the 7^{th} version of B, the 7^{th} version of C, and the 3^{rd} version of D, notated as A3, B6, C6, D2 in FIG. 5.

As shown in FIG. 5B, at time T=2, node 510 compares knowledge K_{N500} received from node 500 against its own knowledge K_{N510} and determines what needs to be sent to node 500. In this example, as a result, node 510 will send node 500 the changes relating to B and D since node 500's knowledge of B3, D0 is behind node 510's knowledge of B6 and D2. When node 510 sends node 500 the changes between B6 and B3, and the changes between D2 and D0, it also sends along the latest version of knowledge K_{N510} it has (reflecting whenever the last change on node 510 was made).

As shown in FIG. 5C, representing time t=3, sending knowledge K_{N510} to node 500 allows node 500 to detect conflicts (e.g., store them for later resolution) if it later finds out that both node 500 and node 510 made a change to an object while they were on the same version. This allows for autonomous updating, efficient enumeration, but also correct conflict detection when the nodes meet and exchange changes. For instance, in the example, if C6 is not the same object in both knowledge K_{N510} and K_{N510}, e.g., if both independently evolved from C5 to C6, then which C6 is the correct C6 can be set aside for conflict resolution, e.g., according to pre-set policy resolution that befits the synchronization scenario and devices involved.

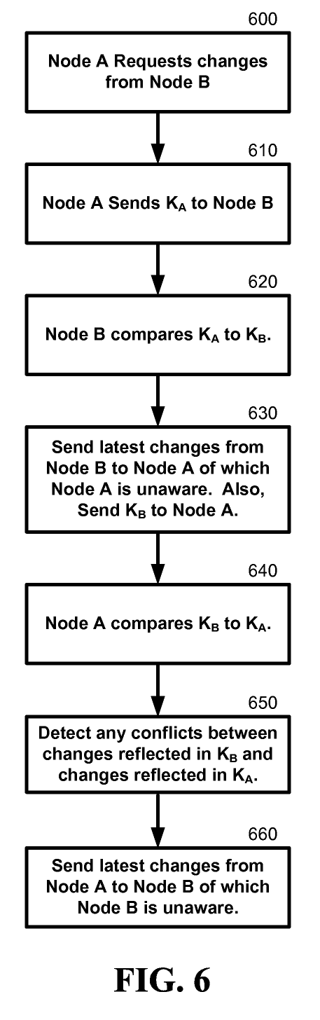

An exemplary knowledge exchange process between any two nodes of a distributed multi-master synchronization environment occurs is shown in the flow diagram of FIG. 6. At 600, node A requests synchronization with node B, thereby asking node B for changes node A does not know about. In order to equip node B, at 610, node A sends its knowledge to node B. At 620, node B compares the knowledge received from node A with its own knowledge to determine what changes node B knows about that should be sent to node A. At 630, node B sends such changes to node A, and in addition, node B sends its knowledge to node A so that node A can perform a similar knowledge comparison at 640.

At 650, node A detects any potential conflicts between latest versions reflected in the knowledge of node B and latest versions reflected in the knowledge of node A, in the event that independent evolution of versions has occurred on node A and node B. In accordance with the invention, any conflict resolution policy may be applied to determine which node trumps the other node in the event of a conflict. At 660, the latest changes from node A that are not possessed by node B are sent to node B. The conflict resolution policy will additionally dictate whether any changes are sent from node B to node A, or node A to node B, to maintain common information between the nodes. If independent versioning is OK, or desirable, no conflict resolution is another option.

The systems and methods for efficiently representing knowledge of the invention may also be applied to the context of resolving in memory data on the same provider. In such context, the in memory data may not be backed by a physical store, e.g., it might be used in a graph solver on the CPU to synchronize nodes. The invention may also be applied in the context of scene graphs, especially as they become more distributed on multi-core architectures and calculations are written directly to an in memory data structure such as a volumetric texture.

### Exemplary Networked and Distributed Environments

One of ordinary skill in the art can appreciate that the synchronization knowledge representation and exchange of the invention can be implemented in connection with any computer or other client or server device, which can be deployed as part of a computer network, or in a distributed computing environment, connected to any kind of data store. In this regard, the present invention pertains to any computer system or environment having any number of memory or storage units, and any number of applications and processes occurring across any number of storage units or volumes, which may be used in connection with synchronization techniques in accordance with the present invention. The present invention may apply to an environment with server computers and client computers deployed in a network environment or a distributed computing environment, having remote or local storage. The present invention may also be applied to standalone computing devices, having programming language functionality, interpretation and execution capabilities for generating, receiving and transmitting information in connection with remote or local services and processes.

Distributed computing provides sharing of computer resources and services by exchange between computing devices and systems. These resources and services include the exchange of information, cache storage and disk storage for objects, such as files. Distributed computing takes advantage of network connectivity, allowing clients to leverage their collective power to benefit the entire enterprise. In this regard, a variety of devices may have applications, objects or resources that may implicate the systems and methods for synchronizing in accordance with the invention.

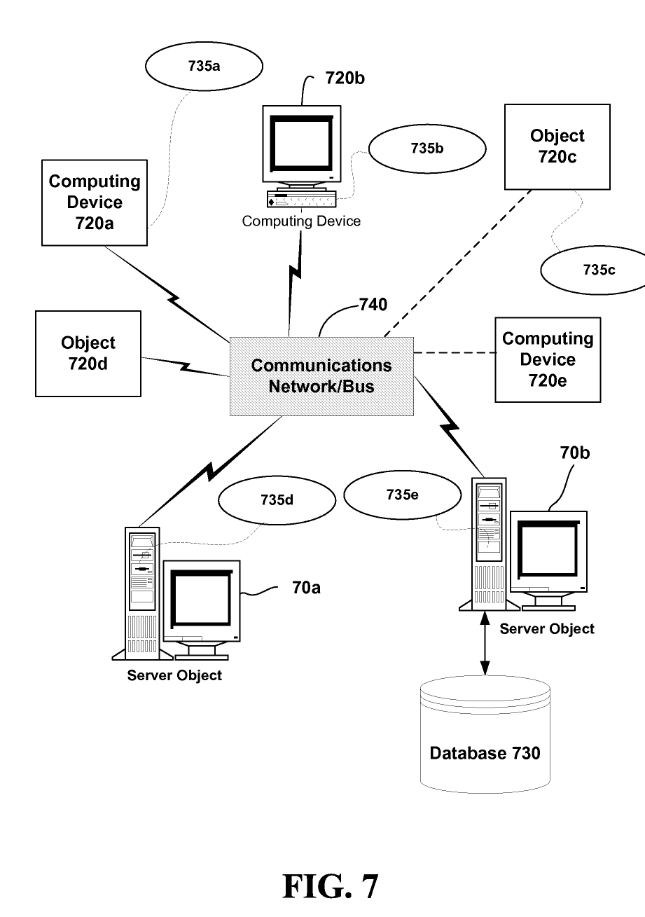

FIG. 7 provides a schematic diagram of an exemplary networked or distributed computing environment. The distributed computing environment comprises computing objects 710a, 710b, etc. and computing objects or devices 720a, 720b, 720c, 720d, 720e, etc. These objects may comprise programs, methods, data stores, programmable logic, etc. The objects may comprise portions of the same or different devices such as PDAs, audio/video devices, MP3 players, personal computers, etc. Each object can communicate with another object by way of the communications network 740. This network may itself comprise other computing objects and computing devices that provide services to the system of FIG. 7, and may itself represent multiple interconnected networks. In accordance with an aspect of the invention, each object 710a, 710b, etc. or 720a, 720b, 720c, 720d, 720e, etc. may contain an application that might make use of an API, or other object, software, firmware and/or hardware, suitable for use with the systems and methods for synchronizing with knowledge in accordance with the invention.

It can also be appreciated that an object, such as 720c, may be hosted on another computing device 710a, 710b, etc. or 720a, 720b, 720c, 720d, 720e, etc. Thus, although the physical environment depicted may show the connected devices as computers, such illustration is merely exemplary and the physical environment may alternatively be depicted or described comprising various digital devices such as PDAs, televisions, MP3 players, etc., any of which may employ a variety of wired and wireless services, software objects such as interfaces, COM objects, and the like.

There are a variety of systems, components, and network configurations that support distributed computing environments. For example, computing systems may be connected together by wired or wireless systems, by local networks or widely distributed networks. Currently, many of the networks are coupled to the Internet, which provides an infrastructure for widely distributed computing and encompasses many different networks. Any of the infrastructures may be used for exemplary communications made incident to synchronizing according to the present invention.

In home networking environments, there are at least four disparate network transport media that may each support a unique protocol, such as Power line, data (both wireless and wired), voice (e.g., telephone) and entertainment media. Most home control devices such as light switches and appliances may use power lines for connectivity. Data Services may enter the home as broadband (e.g., either DSL or Cable modem) and are accessible within the home using either wireless (e.g., HomeRF or 802.11B) or wired (e.g., Home PNA, Cat 5, Ethernet, even power line) connectivity. Voice traffic may enter the home either as wired (e.g., Cat 3) or wireless (e.g., cell phones) and may be distributed within the home using Cat 3 wiring. Entertainment media, or other graphical data, may enter the home either through satellite or cable and is typically distributed in the home using coaxial cable. IEEE 1394 and DVI are also digital interconnects for clusters of media devices. All of these network environments and others that may emerge, or already have emerged, as protocol standards may be interconnected to form a network, such as an intranet, that may be connected to the outside world by way of a wide area network, such as the Internet. In short, a variety of disparate sources exist for the storage and transmission of data, and consequently, any of the computing devices of the present invention may share and communicate data in any existing manner, and no one way described in the embodiments herein is intended to be limiting.

The Internet commonly refers to the collection of networks and gateways that utilize the Transmission Control Protocol/Internet Protocol (TCP/IP) suite of protocols, which are well-known in the art of computer networking. The Internet can be described as a system of geographically distributed remote computer networks interconnected by computers executing networking protocols that allow users to interact and share information over network(s). Because of such wide-spread information sharing, remote networks such as the Internet have thus far generally evolved into an open system with which developers can design software applications for performing specialized operations or services, essentially without restriction.

Thus, the network infrastructure enables a host of network topologies such as client/server, peer-to-peer, or hybrid architectures. The “client” is a member of a class or group that uses the services of another class or group to which it is not related. Thus, in computing, a client is a process, i.e., roughly a set of instructions or tasks, that requests a service provided by another program. The client process utilizes the requested service without having to “know” any working details about the other program or the service itself. In a client/server architecture, particularly a networked system, a client is usually a computer that accesses shared network resources provided by another computer, e.g., a server. In the illustration of FIG. 7, as an example, computers 720a, 720b, 720c, 720d, 720e, etc. can be thought of as clients and computers 710a, 710b, etc. can be thought of as servers where servers 710a, 710b, etc. maintain the data that is then replicated to client computers 720a, 720b, 720c, 720d, 720e, etc., although any computer can be considered a client, a server, or both, depending on the circumstances. Any of these computing devices may be processing data or requesting services or tasks that may implicate the synchronization techniques with knowledge in accordance with the invention.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques for synchronizing based on knowledge in accordance with the invention may be distributed across multiple computing devices or objects.

Client(s) and server(s) communicate with one another utilizing the functionality provided by protocol layer(s). For example, HyperText Transfer Protocol (HTTP) is a common protocol that is used in conjunction with the World Wide Web (WWW), or “the Web.” Typically, a computer network address such as an Internet Protocol (IP) address or other reference such as a Universal Resource Locator (URL) can be used to identify the server or client computers to each other. The network address can be referred to as a URL address. Communication can be provided over a communications medium, e.g., client(s) and server(s) may be coupled to one another via TCP/IP connection(s) for high-capacity communication.

Thus, FIG. 7 illustrates an exemplary networked or distributed environment, with server(s) in communication with client computer (s) via a network/bus, in which the present invention may be employed. In more detail, a number of servers 710a, 710b, etc. are interconnected via a communications network/bus 740, which may be a LAN, WAN, intranet, GSM network, the Internet, etc., with a number of client or remote computing devices 720a, 720b, 720c, 720d, 720e, etc., such as a portable computer, handheld computer, thin client, networked appliance, or other device, such as a VCR, TV, oven, light, heater and the like in accordance with the present invention. It is thus contemplated that the present invention may apply to any computing device in connection with which it is desirable to synchronize any kind of data.

In a network environment in which the communications network/bus 740 is the Internet, for example, the servers 710a, 710b, etc. can be Web servers with which the clients 720a, 720b, 720c, 720d, 720e, etc. communicate via any of a number of known protocols such as HTTP. Servers 710a, 710b, etc. may also serve as clients 720a, 720b, 720c, 720d, 720e, etc., as may be characteristic of a distributed computing environment.

As mentioned, communications may be wired or wireless, or a combination, where appropriate. Client devices 720a, 720b, 720c, 720d, 720e, etc. may or may not communicate via communications network/bus 14, and may have independent communications associated therewith. For example, in the case of a TV or VCR, there may or may not be a networked aspect to the control thereof. Each client computer 720a, 720b, 720c, 720d, 720e, etc. and server computer 710a, 710b, etc. may be equipped with various application program modules or objects 135a, 135b, 135c, etc. and with connections or access to various types of storage elements or objects, across which files or data streams may be stored or to which portion(s) of files or data streams may be downloaded, transmitted or migrated. Any one or more of computers 710a, 710b, 720a, 720b, 720c, 720d, 720e, etc. may be responsible for the maintenance and updating of a database 730 or other storage element, such as a database or memory 730 for storing data processed or saved according to the invention. Thus, the present invention can be utilized in a computer network environment having client computers 720a, 720b, 720c, 720d, 720e, etc. that can access and interact with a computer network/bus 740 and server computers 710a, 710b, etc. that may interact with client computers 720a, 720b, 720c, 720d, 720e, etc. and other like devices, and databases 730.

### Exemplary Computing Device

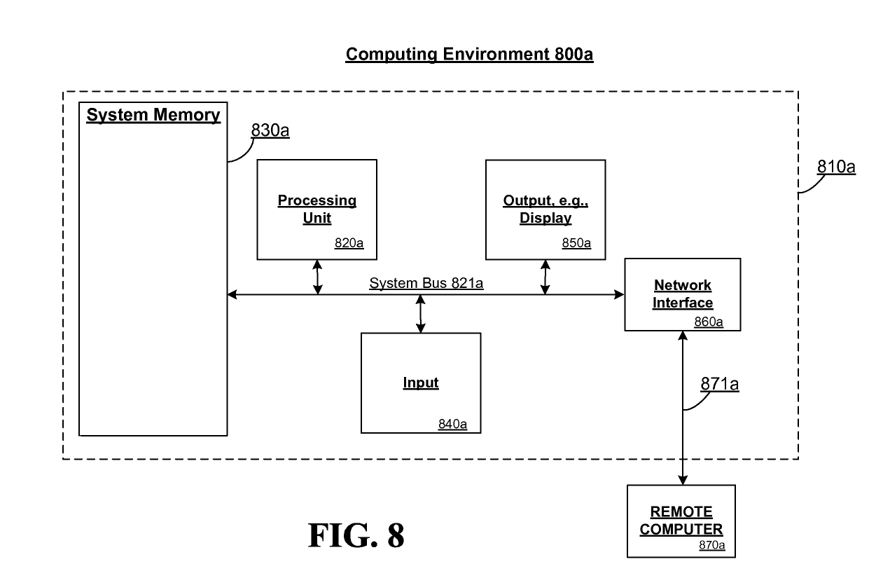

As mentioned, the invention applies to any device wherein it may be desirable to synchronize any kind of data across a set of devices. It should be understood, therefore, that handheld, portable and other computing devices and computing objects of all kinds are contemplated for use in connection with the present invention, i.e., anywhere that a device may benefit from sharing of data across devices or otherwise receive, process or store data. Accordingly, the below general purpose remote computer described below in FIG. 8 is but one example, and the present invention may be implemented with any client having network/bus interoperability and interaction. Thus, the present invention may be implemented in an environment of networked hosted services in which very little or minimal client resources are implicated, e.g., a networked environment in which the client device serves merely as an interface to the network/bus, such as an object placed in an appliance.

Although not required, the invention can partly be implemented via an operating system, for use by a developer of services for a device or object, and/or included within application software that operates in connection with the component(s) of the invention. Software may be described in the general context of computer-executable instructions, such as program modules, being executed by one or more computers, such as client workstations, servers or other devices. Those skilled in the art will appreciate that the invention may be practiced with other computer system configurations and protocols.

FIG. 8 thus illustrates an example of a suitable computing system environment 800a in which the invention may be implemented, although as made clear above, the computing system environment 800a is only one example of a suitable computing environment for a media device and is not intended to suggest any limitation as to the scope of use or functionality of the invention. Neither should the computing environment 800a be interpreted as having any dependency or requirement relating to any one or combination of components illustrated in the exemplary operating environment 800a.

With reference to FIG. 8, an exemplary remote device for implementing the invention includes a general purpose computing device in the form of a computer 810a. Components of computer 810a may include, but are not limited to, a processing unit 820a, a system memory 830a, and a system bus 821a that couples various system components including the system memory to the processing unit 820a. The system bus 821 a may be any of several types of bus structures including a memory bus or memory controller, a peripheral bus, and a local bus using any of a variety of bus architectures.

Computer 810a typically includes a variety of computer readable media. Computer readable media can be any available media that can be accessed by computer 810a. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by computer 810a. Communication media typically embodies computer readable instructions, data structures, program modules or other data in a modulated data signal such as a carrier wave or other transport mechanism and includes any information delivery media.

The system memory 830a may include computer storage media in the form of volatile and/or nonvolatile memory such as read only memory (ROM) and/or random access memory (RAM). A basic input/output system (BIOS), containing the basic routines that help to transfer information between elements within computer 810a, such as during start-up, may be stored in memory 830a. Memory 830a typically also contains data and/or program modules that are immediately accessible to and/or presently being operated on by processing unit 820a. By way of example, and not limitation, memory 830a may also include an operating system, application programs, other program modules, and program data.

The computer 810a may also include other removable/non-removable, volatile/nonvolatile computer storage media. For example, computer 810a could include a hard disk drive that reads from or writes to non-removable, nonvolatile magnetic media, a magnetic disk drive that reads from or writes to a removable, nonvolatile magnetic disk, and/or an optical disk drive that reads from or writes to a removable, nonvolatile optical disk, such as a CD-ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM and the like. A hard disk drive is typically connected to the system bus 821a through a non-removable memory interface such as an interface, and a magnetic disk drive or optical disk drive is typically connected to the system bus 821a by a removable memory interface, such as an interface.

A user may enter commands and information into the computer 810a through input devices such as a keyboard and pointing device, commonly referred to as a mouse, trackball or touch pad. Other input devices may include a microphone, joystick, game pad, satellite dish, scanner, or the like. These and other input devices are often connected to the processing unit 820a through user input 840a and associated interface(s) that are coupled to the system bus 821a, but may be connected by other interface and bus structures, such as a parallel port, game port or a universal serial bus (USB). A graphics subsystem may also be connected to the system bus 821a. A monitor or other type of display device is also connected to the system bus 821a via an interface, such as output interface 850a, which may in turn communicate with video memory. In addition to a monitor, computers may also include other peripheral output devices such as speakers and a printer, which may be connected through output interface 850a.

The computer 810a may operate in a networked or distributed environment using logical connections to one or more other remote computers, such as remote computer 870a, which may in turn have media capabilities different from device 810a. The remote computer 870a may be a personal computer, a server, a router, a network PC, a peer device or other common network node, or any other remote media consumption or transmission device, and may include any or all of the elements described above relative to the computer 810a. The logical connections depicted in FIG. 8 include a network 871a, such local area network (LAN) or a wide area network (WAN), but may also include other networks/buses. Such networking environments are commonplace in homes, offices, enterprise-wide computer networks, intranets and the Internet.

When used in a LAN networking environment, the computer 810a is connected to the LAN 871a through a network interface or adapter. When used in a WAN networking environment, the computer 810a typically includes a communications component, such as a modem, or other means for establishing communications over the WAN, such as the Internet. A communications component, such as a modem, which may be internal or external, may be connected to the system bus 821a via the user input interface of input 840a, or other appropriate mechanism. In a networked environment, program modules depicted relative to the computer 810a, or portions thereof, may be stored in a remote memory storage device. It will be appreciated that the network connections shown and described are exemplary and other means of establishing a communications link between the computers may be used.

There are multiple ways of implementing the present invention, e.g., an appropriate API, tool kit, driver code, operating system, control, standalone or downloadable software object, etc. which enables applications and services to use the systems and methods for representing and exchanging knowledge in accordance with the invention. The invention contemplates the use of the invention from the standpoint of an API (or other software object), as well as from a software or hardware object that performs the knowledge exchange in accordance with the invention. Thus, various implementations of the invention described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned above, while exemplary embodiments of the present invention have been described in connection with various computing devices and network architectures, the underlying concepts may be applied to any computing device or system in which it is desirable to synchronize data with another computing device or system. For instance, the synchronization processes of the invention may be applied to the operating system of a computing device, provided as a separate object on the device, as part of another object, as a reusable control, as a downloadable object from a server, as a “middle man” between a device or object and the network, as a distributed object, as hardware, in memory, a combination of any of the foregoing, etc.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computing device generally includes a processor, a storage medium readable by the processor (including volatile and non-volatile memory and/or storage elements), at least one input device, and at least one output device. One or more programs that may implement or utilize the synchronization services and/or processes of the present invention, e.g., through the use of a data processing API, reusable controls, or the like, are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, etc., the machine becomes an apparatus for practicing the invention. When implemented on a general-purpose processor, the program code combines with the processor to provide a unique apparatus that operates to invoke the functionality of the present invention. Additionally, any storage techniques used in connection with the present invention may invariably be a combination of hardware and software.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) where used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally, it is known that a carrier wave can be employed to carry computer-readable electronic data such as those used in transmitting and receiving electronic mail or in accessing a network such as the Internet or a local area network (LAN).

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of FIG. 6. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

While the present invention has been described in connection with the preferred embodiments of the various figures, it is to be understood that other similar embodiments may be used or modifications and additions may be made to the described embodiment for performing the same function of the present invention without deviating therefrom. For example, while exemplary network environments of the invention are described in the context of a networked environment, such as a peer to peer networked environment, one skilled in the art will recognize that the present invention is not limited thereto, and that the methods, as described in the present application may apply to any computing device or environment, such as a gaming console, handheld computer, portable computer, etc., whether wired or wireless, and may be applied to any number of such computing devices connected via a communications network, and interacting across the network. Furthermore, it should be emphasized that a variety of computer platforms, including handheld device operating systems and other application specific operating systems are contemplated, especially as the number of wireless networked devices continues to proliferate.

While exemplary embodiments refer to utilizing the present invention in the context of particular programming language constructs, the invention is not so limited, but rather may be implemented in any language to provide methods for representing and exchanging knowledge for a set of nodes in accordance with the invention. Still further, the present invention may be implemented in or across a plurality of processing chips or devices, and storage may similarly be effected across a plurality of devices. Therefore, the present invention should not be limited to any single embodiment, but rather should be construed in breadth and scope in accordance with the appended claims.

What is claimed is:

1. A method for synchronizing a set of objects between a first node and a second node of a plurality of nodes connectable via one or more networks, comprising:
initiating synchronization by the first node with the second node including transmitting to the second node knowledge of the first node concerning a set of objects and corresponding versions for the objects of the set of objects represented on the first node;
receiving by the first node first changes to the set of objects from the second node of which the first node is not aware based on a comparison of knowledge of the second node and the knowledge of the first node;
receiving by the first node from the second node the knowledge of the second node concerning the set of objects and corresponding versions of the objects of the set of objects represented on the second node; and
comparing the knowledge of the second node with the knowledge of the first node to determine what second changes to the set of objects to send to the second node of which the second node is unaware.

2. The method of claim 1, further comprising:
transmitting the changes of which the second node is unaware to the second node.

3. The method of claim 1, further comprising:
prior to said initiating, connecting the first node and the second node via a network of the one or more networks.

4. The method of claim 1, further comprising:
applying said first changes to the set of objects represented on the first node to bring the set of objects up to date as of the collective knowledge of the first and second node.

5. The method of claim 1, further comprising updating the first knowledge and corresponding versions represented on the first node based on the first changes.

6. The method of claim 1, wherein said receiving by the first node of first changes to the set of objects from the second node includes receiving by the first node first changes representing knowledge of the latest versions of the set of objects from the second node of which the first node is not aware.

7. The method of claim 1, further comprising:
initiating synchronization by the first node or the second node with a third node including transmitting to the third node knowledge of the first node or second node, respectively, concerning a set of objects and corresponding versions for the objects of the set of objects represented on the first node or the second node, respectively.

8. The method of claim 1, further comprising:
receiving by the first node or second node third changes to the set of objects from a third node of which the first node or second node, respectively, is not aware based on a comparison of knowledge of the third node and the knowledge of the first or second node, respectively; and
receiving by the first node or the second node, respectively, from the third node the knowledge of the third node concerning the set of objects and corresponding versions of the objects of the set of objects represented on the third node.

9. The method of claim 1, further comprising:
comparing the knowledge of a third node with the knowledge of the first node or the second node to determine what changes to the set of objects to send to the third node of which the third node is unaware.

10. The method of claim 1, further comprising:
detecting from the knowledge of the second node and the first node whether an object of the set of objects independently evolved on the first node and second node.

11. The method of claim 1, wherein if an object independently evolves on the first node and second node, determining whether the version of the object on the second node or the version of the object on the first node is the version to propagate to the set of objects of the first and second nodes.

12. The method of claim 11, wherein said determining includes applying a conflict resolution policy for determining whether the version of the object on the first node trumps the version of the object on the second node.

13. A computer readable medium comprising computer executable instructions for carrying out the method of claim 1.

14. A first node of a plurality of nodes connectable via one or more networks that synchronizes a set of objects between the first node and any second node of the plurality of nodes, comprising:
a synchronization component for synchronizing the set of objects between the first node any second node of the plurality of nodes, including:
a synchronization communications component that initiates synchronization with the second node, that transmits to the second node first knowledge about the set of objects including corresponding versions represented on the first node, that receives first changes to the set of objects from the second node about which the first node does not know and that receives second knowledge of the second node about the set of objects and corresponding versions represented on the second node; and
a synchronization analysis component that updates the set of objects represented on the first node and the first knowledge based on said first changes and compares the second knowledge with the first knowledge to determine what second changes to the set of objects to send to the second node about which the second node does not know.

15. The first node of claim 14, wherein the synchronization communications component further transmits the second changes to the second node.

16. The first node of claim 14, wherein the first node and the second node independently evolve the set of objects on the first node and second node, respectively, when the first node or the second disconnects from the one or more networks.

17. The first node of claim 14, wherein if an object of the set of objects independently evolved on the first node and second node, determining whether the version on the second node or the first node is the version to propagate to the set of objects of the first and second nodes.

18. The first node of claim 14, wherein the synchronization communications component initiates synchronization with a third node and transmits to the third node the first knowledge and corresponding versions as updated by the synchronization analysis component, that receives third changes to the set of objects from the third node about which the first node does not know and that receives third knowledge of the third node about the set of objects and corresponding versions represented on the third node.

19. A computing device for synchronizing a set of objects between a first node and a second node of a plurality of nodes connectable via one or more networks, comprising, comprising:
a synchronization initiation component that initiates synchronization by the first node with the second node when connected via the one or more networks;
an input/output component that:
outputs to the second node knowledge of the first node concerning a set of objects including corresponding versions for the objects of the set of objects represented on the first node;
receives first input representing first changes to the set of objects from the second node about which the first node does not have represented in the knowledge of the first node; and
receives second input representing knowledge of the second node concerning the set of objects including corresponding versions of the objects of the set of objects represented on the second node; and
a synchronization analysis component for comparing the knowledge represented by the second input with the knowledge of the first node to determine what second changes to the set of objects to transmit to the second node not represented in the knowledge of the second input.

20. The computing device of claim 19, further comprising:
an authentication component for authenticating that the second node is permitted to synchronize with the first node.
